(19) United States
(12) Patent Application Publication
(10) Pub. No.: US 2013/0099480 A1
(43) Pub. Date: Apr. 25, 2013

(54) Expansion Connector for a Fluid Connection Hose

(71) Applicant: FLUIDMASTER, INC., San Juan Capistrano, CA (US)

(72) Inventors: Bryan Grziwok, Berkeley, CA (US); David Diepersloot, Scotts Valley, CA (US)

(73) Assignee: Fluidmaster, Inc., San Juan Capistrano, CA (US)

(21) Appl. No.: 13/653,179

(22) Filed: Oct. 16, 2012

Related U.S. Application Data
(60) Provisional application No. 61/549,102, filed on Oct. 19, 2011.

(51) Int. Cl. F16L 33/00

(52) U.S. Cl. CPC F16L 33/00
USPC 285/258

(57) ABSTRACT

A fluid connector, having: (a) a flexible tube; (b) an outwardly expandable barbed fitting receivable into a distal end of the flexible tube, wherein the outwardly expandable barbed fitting can be deformed outwardly against an inner surface of the flexible tube; (c) a collar received around the flexible tube; and (d) a hose end connector receivable onto the collar.

### RELATED APPLICATION

The present application claims priority to U.S. Provisional Patent Application 61/549,102, filed Oct. 19, 2011, of the same title, the entire disclosure of which is incorporated herein by reference in its entirety for all purposes.

### TECHNICAL FIELD

The present invention relates to fluid hose connectors.

### BACKGROUND OF THE INVENTION

Currently, fluid hose lines are typically connected together (or to fixtures) by compressively crimping a thin walled collar at the end of one fluid line onto the end of the other fluid line (or fixture). The crimped external surface is then left exposed. The primary disadvantage of this common external crimping method is that the end result does not look attractive due to the bending and deforming of the outer surface of the connector. In addition, excessive crimping may even interfere with fluid flow through the line if the flow path becomes oval as opposed to circular in cross section.

A second disadvantage of external crimping is that the crimping prevents the movement of the nut back over the crimp. Unfortunately, if the nut could be backed off over the crimp, it may instead allow for better access during the installation.

What would instead be desired is a system for crimping together the ends of two fluid lines (or a fluid line and a fixture), yet still providing an aesthetic solution such that the external surface of the connection is not deformed. As will be seen, the present invention provides such an attractive cosmetic solution without compromising connector performance.

### SUMMARY OF THE INVENTION

The present invention provides a fluid hose line connector that uses hydraulic or mechanical methods to expand an inner barbed fitting into a fluid tube to secure together a connector assembly at the end of the fluid tube. Existing systems crimp inwardly onto a barbed connector. In contrast, in the present invention, the barbed fastener is expanded outwardly to make the connection secure.

In one preferred aspect, the present invention provides a fluid connector, comprising: (a) a flexible tube; (b) an outwardly expandable barbed fitting receivable into a distal end of the flexible tube, wherein the outwardly expandable barbed fitting can be deformed outwardly against an inner surface of the flexible tube; (c) a collar received around the flexible tube; (d) a hose end connector (e.g.: a nut) receivable onto the collar; and (e) a washer received onto the outwardly expandable barbed fitting.

In another preferred aspect, the present invention provides a method of assembling a fluid connector, comprising: (a) providing a flexible tube; (b) providing a collar around the flexible tube; (c) providing a hose end connector receivable onto the collar; (d) inserting an outwardly expandable barbed fitting through both the hose end connector and collar and into a distal end of the flexible tube; and (e) outwardly expanding the outwardly expandable barbed fitting such that the barbs are pushed into an inner surface of the flexible tube, thereby securing the outwardly expandable barbed fitting into the flexible tube.

The outwardly expandable barbed fitting can be mechanically or hydraulically deformed outwardly against the inner surface of the flexible tube, thereby pushing the barbs into the inner surface of the flexible tube, securing the connector assembly together.

Optionally, the outwardly expandable barbed fitting can be mechanically expanded into the inner surface of the flexible tube by an expandable bladder.

Optionally as well, the outwardly expandable barbed fitting can be hydraulically expanded into the inner surface of the flexible tube by increasing fluid pressure within the barbed fitting.

### BRIEF DESCRIPTION OF THE DRAWINGS:

FIG. 1A is a front perspective view of the present fluid connector.

FIG. 1B is a rear perspective view of the present fluid connector.

FIG. 2A is a sectional side elevation view of the present fluid connector prior to outward expansion of the barbed fitting.

FIG. 2B is a sectional side elevation view of the present fluid connector after outward expansion of the barbed fitting.

FIG. 3 is a front elevation view. Line 2-2 shows where sectional views 2A and 2B are taken.

FIG. 4A is an illustration of an expandable bladder being used to outwardly expand the barbed fitting, prior to expansion.

FIG. 4B is an illustration of an expandable bladder being used to outwardly expand the barbed fitting, during expansion.

FIG. 5 shows the present fluid connector fastened onto a fluid line or fixture.

### DETAILED DESCRIPTION OF THE DRAWINGS:

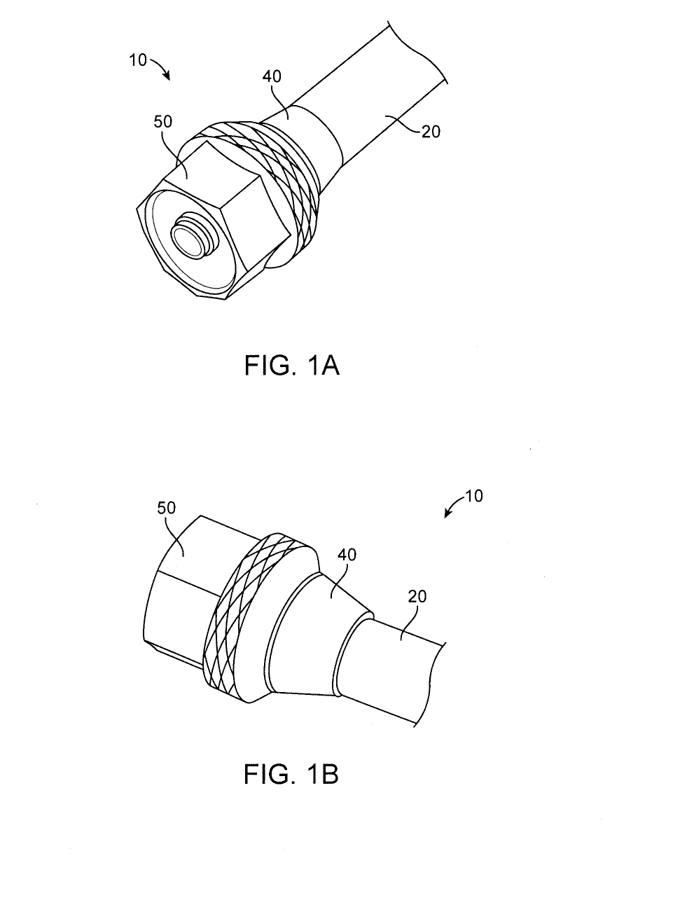

FIGS. 1A and 1B show front and rear perspective views of fluid connector assembly 10. It is to be understood that fluid connector assembly 10 can be used for water, or other industrial fluids (such as hydraulic fluid). It is also to be understood that the present invention can either be used to connect a fluid line to another fluid line or to a fixture.

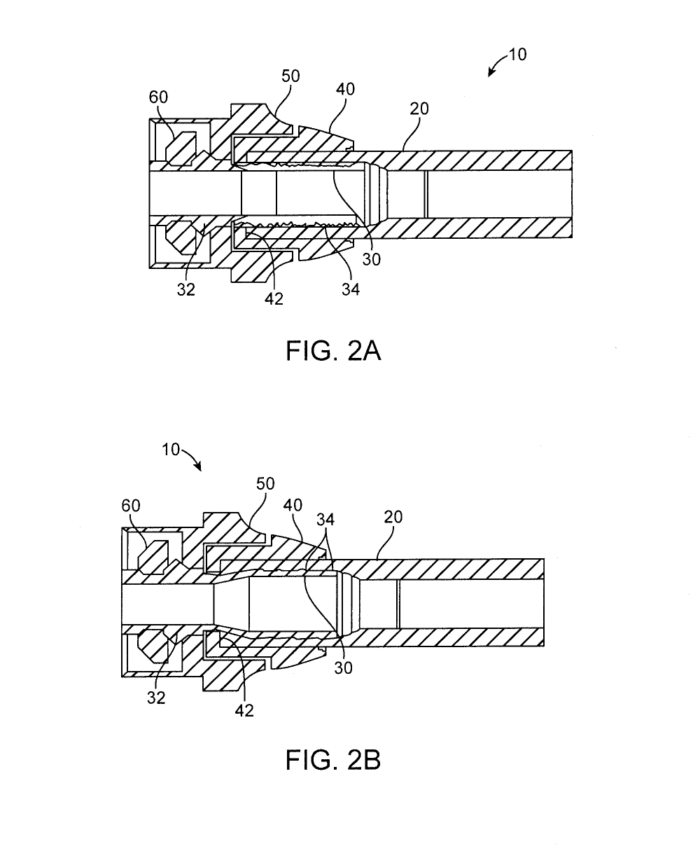

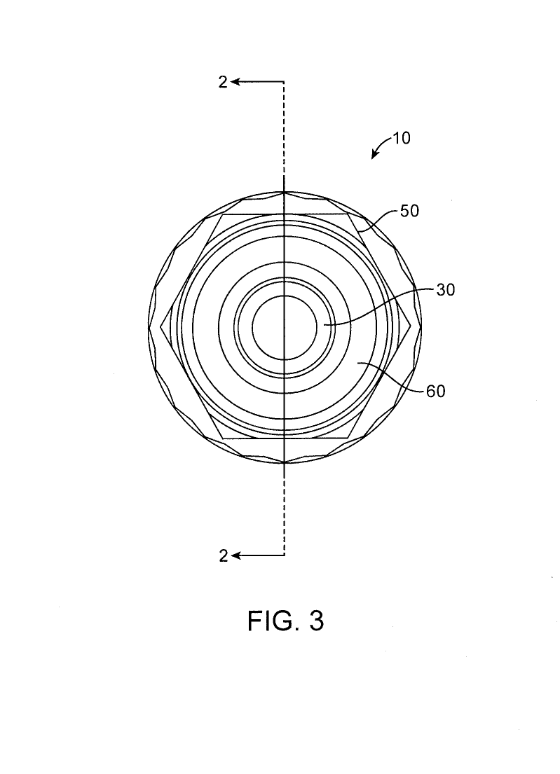

FIG. 2A shows a sectional side elevation view (taken along line 2-2 in FIG. 3) prior to the barbed connector 30 being expanded, and FIG. 2B shows a similar view after the barbed connector 30 has been expanded, as follows.

Referring first to FIG. 2A, the present invention provides a fluid connector assembly 10. Connector assembly 10 comprises: a flexible tube 20; an outwardly expandable barbed fitting 30 receivable into the distal end of flexible tube 20. A collar 40 is received around the distal end of flexible tube 20; and a hose end connector (which may optionally comprise a nut) 50 is receivable collar 40, as shown.

A washer 60 is received onto outwardly expandable barbed fitting 30. As can be seen, washer 60 is also received within nut 50. As can also be seen, hose end connector 50 may optionally be received axially around an outer surface of collar 40 as well.

Optionally as well, outwardly expandable barbed fitting 30 has a shoulder 32 onto which hose end connector 50 is received. Shoulder 32 holds nut 50 against collar 40 after the outwardly expandable barbed fitting 30 is received into the distal end of flexible tube 20, as shown. Optionally as well, collar 40 has a distal lip 42 that can be received against the distal end of flexible tube 20, as shown.

Next, as seen in FIG. 2B, the outwardly expandable barbed fitting 30 is deformed outwardly against an inner surface of flexible tube 20, thereby pushing barbs 34 into the inner surface of flexible tube 20, as shown.

In optional aspects, outwardly expandable barbed fitting 30 can be either hydraulically or mechanically deformed outwardly against the inner surface of flexible tube 20.

For example, outwardly expandable barbed fitting 30 can be hydraulically deformed outwardly by simply increasing the fluid pressure within the outwardly expandable barbed fitting (i.e.: increasing the fluid pressure passing through the connector assembly 10).

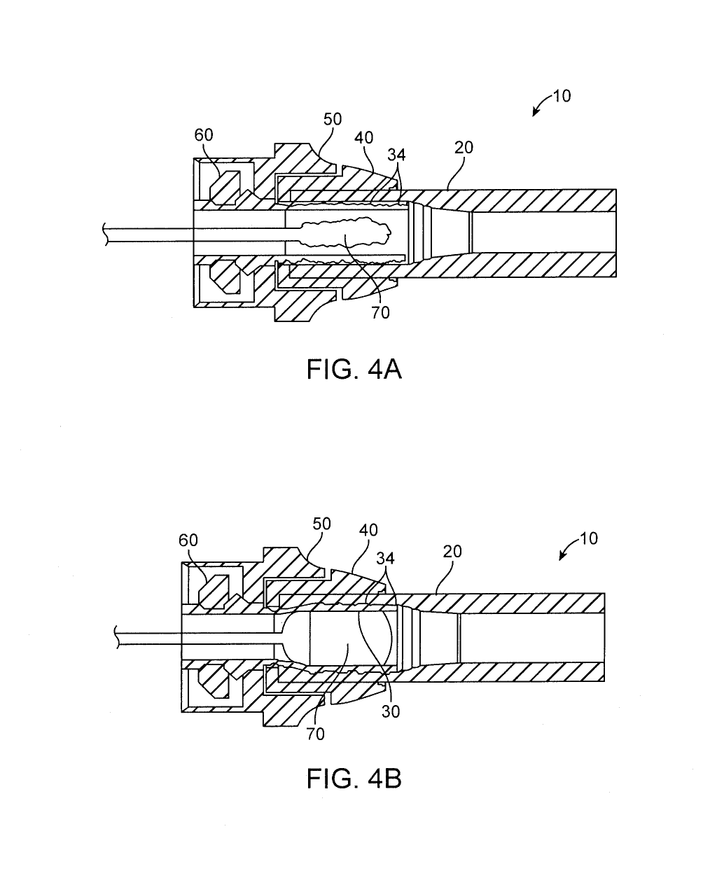

Conversely, as illustrated in FIGS. 4A and 4B, the outwardly expandable barbed fitting 30 can be mechanically expanded by inserting an expandable bladder 70 positioned in the outwardly expandable barbed fitting. In FIG. 4A, a deflated expandable bladder 70 is first inserted into outwardly expandable barbed fitting 30. Next, as seen in FIG. 4B, expandable bladder 70 is inflated, thereby deforming barbed fitting 30 outwards such that the barbs 34 push into the inner side of flexible tube 20, thereby anchoring connector 10 together.

In optional aspects, outwardly expandable barbed fitting 30 may be made of brass, urethane or any other suitable material, and flexible tube 20 may be made of wire or fiber wrapped around a tube, or extruded into the tube. The tube itself may be made of urethane, polyethylene, other resins or other suitable materials. It is to be understood, however, that these material choices are exemplary and not limiting, and that other materials may be substituted, all keeping within the scope of the present invention.

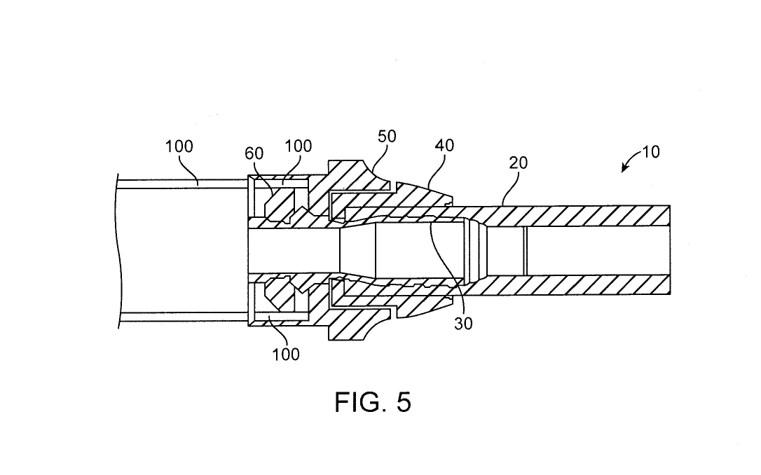

Finally, as seen in FIG. 5, fluid connector 10 may be fastened onto a fluid line or fixture, as follows. Fluid connector 10 may be connected onto fixture/fluid line 100 by inserting an end of fluid line 100 between the washer 60 and the nut 50, as shown. Next, hose end connector 50 may (optionally) be rotated to tighten fluid connector 10 onto fluid line 100. As stated above, hose end connector 50 may optionally be a nut as illustrated. However, it is to be understood that hose end connector 50 is not specifically limited to a nut as show. It may instead be a male or female nut, or any other suitable hose end connector (both threaded and non-threaded).

What is claimed is:

1. A fluid connector, comprising:
(a) a flexible tube;
(b) an outwardly expandable barbed fitting receivable into a distal end of the flexible tube, wherein the outwardly expandable barbed fitting can be deformed outwardly against an inner surface of the flexible tube;
(c) a collar received around the flexible tube; and
(d) a hose end connector receivable onto the collar.

2. The fluid connector of claim 1, wherein the outwardly expandable barbed fitting can be mechanically or hydraulically deformed outwardly against the inner surface of the flexible tube, thereby pushing the barbs into the inner surface of the flexible tube.

3. The fluid connector of claim 1, further comprising:
(e) a washer received onto the outwardly expandable barbed fitting, and wherein the washer is received within the hose end connector.

4. The fluid connector of claim 1, wherein the hose end connector is received around an outer surface of the collar.

5. The fluid connector of claim 1, wherein the outwardly expandable barbed fitting has a shoulder onto which the hose end connector is received, and wherein the shoulder holds the hose end connector against the collar when the outwardly expandable barbed fitting is received into the distal end of the flexible tube.

6. The fluid connector of claim 1, wherein the hose end connector extends axially over the collar.

7. The fluid connector of claim 1, wherein the collar has a distal lip that is received against the distal end of the flexible tube.

8. The fluid connector of claim 1, wherein the outwardly expandable barbed fitting is made of brass or urethane.

9. The fluid connector of claim 1, wherein the flexible tube comprises a tube with wire or fiber wrapped therearound, or extruded therein.

10. A method of assembling a fluid connector, comprising:
(a) providing a flexible tube;
(b) providing a collar around the flexible tube;
(c) providing a hose end connector receivable onto the collar;
(d) inserting an outwardly expandable barbed fitting through both the hose end connector and collar and into a distal end of the flexible tube; and then
(e) outwardly expanding the outwardly expandable barbed fitting such that the barbs are pushed into an inner surface of the flexible tube, thereby securing the outwardly expandable barbed fitting into the flexible tube.

11. The method of claim 10, wherein the outwardly expandable barbed fitting is mechanically expanded into the inner surface of the flexible tube.

12. The method of claim 11, wherein the outwardly expandable barbed fitting is mechanically expanded by an expandable bladder positioned in the outwardly expandable barbed fitting.

13. The method of claim 10, wherein the outwardly expandable barbed fitting is hydraulically expanded into the inner surface of the flexible tube.

14. The method of claim 13, wherein the outwardly expandable barbed fitting is hydraulically expanded by increasing fluid pressure within the outwardly expandable barbed fitting.
